(19) United States
(12) Patent Application Publication
(10) Pub. No.: US 2022/0370977 A1
(43) Pub. Date: Nov. 24, 2022

(54) Liquid Flow Formation Method and Object Moving Method Using Same

(71) Applicant: The Doshisha, Kyoto-shi, Kyoto (JP)

(72) Inventors: Takahiro Kenmotsu, Kyotanabe-shi, Kyoto (JP); Kenichi Yoshikawa, Kyotanabe-shi, Kyoto (JP); Satoshi Takatori, Kyotanabe-shi, Kyoto (JP); Mayu Shono, Kyotanabe-shi, Kyoto (JP)

(73) Assignee: The Doshisha, Kyoto-shi, Kyoto (JP)

(21) Appl. No.: 17/762,924

(22) PCT Filed: Sep. 15, 2020
(86) PCT No.: PCT/JP2020/034976

§ 371 Date: Mar. 23, 2022

(30) Foreign Application Priority Data
Sep. 24, 2019 (JP) 2019-172863

(51) Int. Cl. B01J 19/12; B82Y 15/00; B82Y 40/00

(52) U.S. Cl. CPC B01J 19/12; B82Y 15/00; B82Y 40/00

(57) ABSTRACT

The present disclosure provides a method for forming a liquid flow in a surface region of a liquid, and a method for moving a larger object in a non-contact and non-invasive manner.

### FIELD OF INVENTION

The present invention relates to a method for forming a flow of a liquid (that is, a liquid flow) using laser beams and a method for moving an object using thus formed liquid flow.

### BACKGROUND ART

Optical tweezers are known as a means for manipulating fine particles using laser beams. The optical tweezers are a well-known technique, which traps an object near a focal point of the laser beams by utilizing the attraction force action associated with the refraction of the laser beams near the focal point. For example, the optical tweezers are explained in “Groundbreaking Inventions in Laser Physics “Optical Tweezers” and “High-Intensity Ultrashort Optical Pulse Laser”” (“Chemistry”, vol. 73, No. 12 (published in December 2018), and “Optical Tweezers”, Journal of Low Temperature and Materials Sciences (Kyoto University), No. 7 (published in November 2005) (see Non-Patent Documents 1 and 2 below).

In case that a size of the fine particles is larger than a wavelength of the beam, irradiation of the fine particles dispersed in a liquid with the beams causes Mie scattering. At this time, when the beams are concentrated through a lens and the fine particles are irradiated with the concentrated beams, forces act on the fine particles when the beams enter into and exit from the fine particles, and forces act on the fine particles due to refraction and reflection of the beams at the surfaces of the fine particles. As a result of the forces acting on the fine particles in this way, the fine particles are attracted to the vicinity of the focusing point.

Further, in case that the size of the fine particles is sufficiently smaller than the wavelength of the beam, when the fine particles dispersed in the liquid are irradiated with the beams, Rayleigh scattering occurs. At this time, the beams, which are electromagnetic waves, generate an induced dipole in the fine particles, and interaction between the induced dipole and the electromagnetic field causes an attraction forces in the direction toward the focusing point. As a result, the fine particles can be attracted to the vicinity of the focusing point.

In either case, the fine particles can be attracted, that is, held, in the vicinity of the focusing point. By utilizing this, the fine particles can be retained, and the fine particles can be moved, for example, by changing the position of the focusing point. Such an operation using the light beams can be applied as tweezers that handle the fine particles non-invasively without touching the fine particles as an object. Such optical tweezers can be used, for example, for manipulating and moving minute objects such as proteins, DNA or the like. Such optical tweezers can capture fine particles in a dispersion medium at a focusing point of the light beams. Therefore, by moving the focusing point, it is possible to move minute objects having a size of several tens of micrometers or less (usually 0.1 μm to 50 μm). However, it is desired to move a larger object, specifically an object having a size of the order of millimeters. In addition, it is necessary to use a high-magnification convex lens in order to capture and move an object by means of the optical tweezers, and in this case, in general, the distance from the lens to the object must be 1 mm or less, which greatly restricts the degree of freedom of the operation.

### PRIOR ART REFERENCES

### Non-Patent Documents

Non-Patent Document 1

Hiroshi Masuhara and Nobuaki Nakajima, “Groundbreaking Inventions in Laser Physics “Optical Tweezers” and “High-Intensity Ultrashort Optical Pulse Laser”” (“Chemistry”, vol. 73, No. 12 (published in December 2018)

Non-Patent Document 2

Masahiro Nishiyama and Kenji Okamoto, “Optical Tweezers”, Journal of Low Temperature and Materials Sciences (Kyoto University), No. 7 (published in November 2005)

### SUMMARY OF INVENTION

### Problem to be Solved by Invention

When using the optical tweezers, individual fine particle as an object can be manipulated in a non-contact and non-invasive manner. However, when considering their practicality, it is desirable to be able to manipulate a larger object having a size larger than, for example, several hundreds of micrometers.

### Means to Solve Problem

As a result of diligent studies by the inventors to solve the above problem, it has been found that the above problem can be solved by that a specific region of a surface of a liquid containing dispersed fine particles therein which liquid efficiently absorbs an energy of laser beams (which region is hereinafter also referred to as “specific surface region” of the liquid) is irradiated with laser beams and the fine particles dispersed in the specific surface region absorb the irradiated laser beams such that a temperature of the specific surface region is high relative to that of other region around the specific surface ration so as to form a temperature gradient, and thereby to form a surface tension gradient of the liquid in the surface region of the liquid, whereby a flow of the liquid (that is, a liquid flow) is formed in the surface region of the liquid. Also, the above problem can be solved by controlling the flow with changing a direction and/or a position of the irradiation with the laser beams.

Therefore, in the first aspect, the present invention provides a method for forming a liquid flow in a surface region of a liquid, which is characterized in that a specific surface region of the liquid containing dispersed fine particles is irradiated with laser beams such that a temperature of the specific surface region of the liquid is high relative to that of other surface region around the specific surface region to form a temperature gradient between both surface regions of the liquid. When the temperature gradient is thus formed in the surface of the liquid, a surface tension gradient is formed correspondingly to the temperature gradient, which results in that an amount of the liquid flows from the specific surface region at a high temperature toward said other surface region at the relatively low temperature around the specific surface region, that is a liquid flow is formed. In other words, the surface tension gradient generated by the formation of the temperature gradient serves as a driving source to form the liquid flow. In general, the surface tension is temperature-dependent, and the higher the temperature, the smaller the surface tension (hence, the surface tension of the specific surface region becomes relatively smaller). It should be noted that the “specific surface region” of the liquid is an area to be irradiated with the laser beams, and the term “around” means that the region around the specific surface region to be irradiated exists adjacent to and outside the periphery of the “specific surface region” (hence, the region around the specific surface region is not irradiated).

In the present invention, in order to form the above-described temperature gradient in the surface region of the liquid, it is necessary to heat the specific surface region to a relatively high temperature. Therefore, the surface region of the liquid is configured in order that the specific surface region efficiently absorbs the energy of the laser beams applied to the specific surface region. Specifically, a liquid containing the dispersed fine particles that efficiently absorbs laser beams is used, and the fine particles are preferably dispersed substantially uniformly in the liquid.

In the method for forming the fluid flow of the present invention, in one embodiment, the liquid containing fine particles may be contained in any appropriate container that can contain the liquid as far as it can form a condition in which a gas phase is adjacent to the surface region of the liquid where the liquid flow is to be formed. Such containers may be of, for example, various forms of containers, various forms of tubes, various forms of flow passages, channels, and the like. The material constituting the container is preferably a material through which the laser beams can pass, and for example, a transparent glass material, a plastic material, or the like. In a particularly preferred embodiment, the container is a so-called transparent glass container, microchannel, or the like.

In one preferred embodiment, the container is a transparent glass container, a transparent plastic container, or the like, and the liquid is held in a state wherein it is adjacent to a gas phase in the flow path of the container. In such a container, the gas phase adjacent to the surface region of the liquid may be opened or closed to the surrounding environment of the container. More specifically, the container may have or may not have a portion that functions as the cover (i.e. a lid portion). The lid portion needs to be permeable to the laser beams when the laser beams are applied to the specific surface region through the lid portion.

In other preferred embodiment, the lid portion may encapsulate the liquid in the container such that there is substantially no gas phase adjacent to the liquid. Such a container may be, for example, various microchips, and more specifically, the container may be a part of various containers that defines a micro-space such as a micro-channel of a microchip, a micro-mixer (a micro-portion having a mixing function) or the like. More specifically, the container may be a micro-space of a microchip (for example, a micro-channel portion, a micro-mixer portion, etc.) such as a biochip (for example, an antibody detection chip used for an immunoassay), a tissue chip (Organ on a Chip), or an in vitro human model (BOC (Body on a Chip)).

Hereinafter, the present invention will be further described by taking, as an example, a case where the liquid is contained in an open glass container as described above. As used herein, the term glass container means a container made of a glass material in which a flow path has, for example, a rectangular cross section, and the width and the depth of the cross section of the flow path have a size of the order of several millimeters. For example, the container can be exemplified with a width of 8 mm and a depth of 13 mm. The length of the flow path is not particularly limited, but may be, for example, of the order of millimeters. Specifically, the length may be 30 mm to 200 mm. In other embodiment, the length may be, for example, of the order of micrometers, and specifically the length may be 1 μm to 1000 μm. In such glass container, the liquid has an interface with a gas phase (for example, air), that is a gas-liquid interface, as a surface. It should be noted that the glass container may be one having a different shape of the cross section of which equivalent diameter is similar to that of the cross section of the above described glass container. It is of course that the flow path may be a narrower channel having a cross-sectional size of the order of micrometers.

In the second aspect, the present invention provides a method for moving an object. In the method for forming the liquid flow of the first aspect of the present invention, it is characterized in that while an object intended to move is floated on the surface region of the liquid, the surface region where the object is floated or a surface region in the vicinity of the former surface region is regarded as the “specific surface region of the liquid” and irradiated with the laser beams to form the liquid flow so that the floated object is moved on the surface of thus formed liquid flow. The surface region where the object is floated means a surface region of the liquid which has the floated object therein, and the object may be floated on the surface region of the liquid and/or at least a portion thereof may be inside the surface region of the liquid. The term “floated” is intended to cover both of these conditions.

### Effects of Invention

In the method for forming the liquid flow of the present invention, the fine particles are dispersed in the liquid, and the fine particles contained in the specific surface region of the liquid absorb the energy of the irradiated laser beams to heat the liquid in that region, whereby the temperature gradient in the surface region of the liquid is formed, and thereby the surface tension gradient is formed correspondingly, which results in forming the liquid flow in the surface region of the liquid. That is, in the present invention, the liquid in the specific surface region as a mass is heated through the dispersed particles, whereby the liquid flow is formed as a mass from that region toward the region adjacent to it. That is, an amount of the liquid itself is moved.

Moving the liquid as a mass in this way means that a large force acts on an amount of the liquid. Therefore, in the method for moving the object of the present invention, the object is floated on the specific surface region of the liquid or on the surface region of the liquid in the vicinity of the specific surface region (for example, the surface region adjacent to the specific surface region), and the liquid flow is formed. When the object, in one embodiment, a relatively large object (for example, one having a size of several hundreds of micrometers to several millimeters) is floated on thus formed liquid flow, it can be moved without directly being touched.

### BRIEF DESCRIPTION OF DRAWINGS

FIG. 1 shows an embodiment of irradiating a specific surface region of a liquid with laser beams in parallel to the surface of the liquid, wherein FIG. 1(a) schematically shows a state in which a transparent container made of a transparent material is viewed from a side of the container which contains, as the liquid, water including dispersed fine particles, and FIG. 1(b) schematically shows a state when the transparent container is viewed from its above.

FIG. 2 shows an embodiment in which a specific surface region of a liquid is irradiated with laser beams obliquely with respect to the liquid surface so as to cause total reflection of the beams at the liquid surface, wherein FIG. 2(a) schematically shows a state in which a transparent container made of a transparent material is viewed from a side of the container which contains, as the liquid, water including dispersed fine particles, and FIG. 2(b) schematically shows a state when the transparent container is viewed from its above.

FIG. 3 shows an embodiment of moving an object floated on a liquid surface, wherein FIG. 3(a) schematically shows a state in which a transparent container made of a transparent material is viewed from a side of the container which contains, as the liquid, water including dispersed fine particles, and FIG. 3(b) schematically shows a state when the transparent container is viewed from its above.

FIG. 4 is a graph showing measurement results of an absorption coefficient of water containing gold nanoparticles used in Example 1 and a wavelength.

FIG. 5 schematically shows a state of switching in Example 3 when viewed from a side of the transparent container, wherein FIG. 5(a) schematically shows a case where an object is moved leftward, and FIG. 5(b) schematically shows a case where the object is moved rightward.

### EMBODIMENTS TO CARRY OUT INVENTION

Hereinafter, the present inventions will be described in more detail with reference to the accompanying drawings by taking specific embodiments as examples, but the present invention is not limited to such embodiments.

In one embodiment of the method for forming a liquid flow of the present invention, an intended specific surface region of the liquid is directly irradiated with the laser beams. In other embodiment, the laser beams are injected into the liquid in the container through a wall member (thus indirectly) of the container formed of a material that transmits the laser beams (a material that absorbs a small amount of the laser beam) so that the specific surface region is irradiated with the laser beams. This latter embodiment is applicable, for example, when the liquid is stored in the transparent container made of such material and the laser beams are made incident on the inside of the container through a channel wall from the outside of the transparent container. Therefore, the wall member of the channel has a property of transmitting laser beams, that is, the member is transparent to the laser beams.

In the method of the present invention, the liquid which contains the fine particles is not particularly limited, and may be any suitable liquid wherein an intended liquid flow is formed. In one embodiment, the liquid may be water or an aqueous solution in view of, for example, its stability, a magnitude of its surface tension and the like. Further, a gas phase adjacent to the surface region of the liquid may be of any suitable gas, and in one preferred embodiment, the gas phase may be of nitrogen, air or the like. For example, when a liquid is placed in the transparent container, the surface region exists on the liquid side of the interface between air and the liquid (the gas-liquid interface). In other embodiment, the method for forming the liquid flow as well as the method for moving the object using the same according to the present invention may be applied to, instead of the gas-liquid interface, a liquid-liquid interface, for example, an interface between for example water and an oil, an ordinary oil and a fluorine-based oil, or the like wherein the interface tension becomes large between them.

The fine particles contained in the liquid absorb at least a portion and preferably a larger proportion of the energy of the irradiated laser beams. The term “efficiently absorb” means that the liquid which contains the fine particles has a maximum beam absorption coefficient (for example, molar absorption coefficient) at or near a wavelength of the irradiated beams (preferably within the range of the irradiated beam wavelength ±40 nm, more preferably the irradiated beam wavelength ±25 nm, and for example the irradiated beam wavelength ±10 nm), Such liquid preferably contains, for example, so-called nanoparticles, particularly metal nanoparticles (for example, gold nanoparticles, silver nanoparticles, or the like). All of such fine particles are commercially available, and appropriate fine particles can be selected and dispersed in the intended liquid for use. In other embodiment, graphite particles or carbon nanotubes can be used as the fine particles.

The size of the fine particles is not particularly limited, but the fine particles can be used of which average particle size based on the length thereof is preferably 1 nm to 100 nm, more preferably 1 nm to 60 nm, particularly preferably 5 nm to 50 nm, and for example 10 nm to 15 nm. Such average particle size is generally suitable when the laser beams are used according to the present inventions. For example, when laser beams having a wavelength of 532 nm is used, such average particle size is particularly suitable. It is noted that when fine particles having a specifically larger size (larger particles having a diameter of, for example, about 5 μm to 50 μm) are contained, such particles may be ignored upon calculating the average particle size since such particles do not provide an adverse effect but they cannot be expected to function as the fine particles of the present invention.

In the method for forming the fluid flow of the present invention, the gold nanoparticles can be mentioned as a specific example of the fine particles that are preferably used by being dispersed in the liquid. For example, spherical gold nanoparticles (gold nanoparticles with a diameter of about 15 nm) can be used which are obtained by reducing chloroauric acid (HAuCl₄) with citric acid in water. The gold nanoparticles used in the Examples described later were obtained by this method and had an average particle diameter of 15 nm. Agglomerations of the gold nanoparticles due to change in time were observed, and the larger nanoparticles were also included which had a particle diameter of about 30 μm. With such gold nanoparticles, the maximum absorption is observed in a wavelength region of 522±20 nm (that is, a wavelength showing the maximum absorption coefficient is 522±20 nm), and they efficiently absorb energy of the laser beams having a wavelength of 532 nm.

An amount (that is, a content) of the fine particles contained in the liquid is not particularly limited, but is generally 0.5×10⁻⁸% by mass to 10.0×10⁻⁸ by mass, and preferably 0.7×10⁻⁸% by mass to 6.0×10⁻⁸% by mass based on the mass of the liquid containing the fine particles. It is preferable to select the content of the fine particles so that the wavelength of the laser beams used matches or is close to the wavelength at which a large absorption coefficient and preferably the maximum absorption coefficient of the liquid is observed. These content ranges are applicable when using generally commercially available fine particles, especially also the metal nanoparticles. It is noted that when the content is too large, there may be a problem in that the fine particles aggregate and the beam energy is not absorbed as predetermined, and when it is too small, there may be a problem in that the beam energy is absorbed insufficiently.

The laser beams are not particularly limited, but it is preferable to use a laser that emits beams having a wavelength at which the liquid containing the dispersed fine particles efficiently absorbs the light beam energy. In other words, it is preferable to use, as a liquid containing dispersed fine particles which liquid efficiently absorbs light energy, a liquid having a large absorption coefficient, and preferably the maximum absorption coefficient at or near the wavelength of the beams emitted by the laser used. Therefore, since the absorption coefficient depends on kinds of the fine particles used (and thus a kind, size and content of the fine particles) and the liquid used, it is preferable to select an appropriate combination of the large absorption coefficient and the wavelength of the laser beams.

It is noted that the maximum absorption coefficient of the liquid can be obtained by preparing a sample of the dispersion liquid in which the fine particles of the kind and the content intended for use are contained in the liquid intended for use, and putting the sample in a cell of a device for the measurement of the absorption coefficients so as to obtain an absorption coefficient distribution. Based on the results thereof, a laser light is selected that emits beams having a wavelength at which the maximum absorption coefficient is observed or a wavelength in the vicinity of such wavelength. By selecting the kinds and the amounts of the liquid and the fine particles to be used, it is possible to determine the wavelength of the laser beams which are preferably used. Specifically, at the wavelength of the laser beams used (for example, 500 nm to 560 nm), the liquid containing the fine particles preferably shows an absorption coefficient of 1×10⁸ M⁻¹ cm⁻¹ or more. It more preferably shows an absorption coefficient of 9.5×10⁸ M⁻¹ cm⁻¹ to 14×10⁸ for example 12×10⁸ M⁻¹ cm⁻¹ to 14×10⁸ M⁻¹ cm⁻¹.

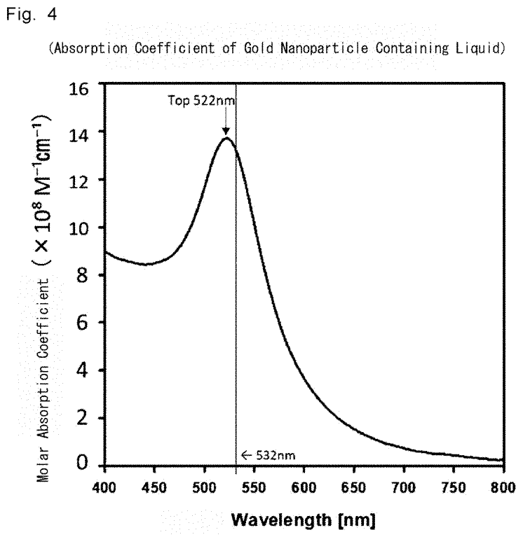

For example, when using a laser that emits green beams (wavelength: 532 nm), water can be used as the liquid in which gold nanoparticles that show the maximum absorption coefficient at 522 nm are dispersed at a content of 2.2×10⁻⁸% by mass (of which average particle size of the nanoparticles can be calculated from the wavelength at which the absorption coefficient shows a peak: about 15 nm). The water containing the gold nanoparticles shows an absorption coefficient of, for example, 13.8×10⁸ M⁻¹ cm⁻¹ at 522 nm (see the absorption coefficient distribution shown in FIG. 4).

A power (output) of the laser can be appropriately selected in consideration of the type of liquid to be used, the type and an amount of the fine particles to be used, and the like. For example, a laser can be used which has a power range of 400 mW to 1000 mW and a beam diameter of 3 mm.

The term “surface region” means a region on the liquid side of the gas-liquid interface of the liquid which contains the fine particles, in which region the influence of the surface tension gradient caused by the irradiation of the laser beams actually occurs. The surface region depends on the conditions of the liquid, the fine particles, the laser beams and the like to be used, and it is generally intended to mean a liquid region present in an area of which depth is preferably up to 1500 μm, and more preferably up to 1000 μm from the gas-liquid interface.

In one preferred embodiment, the laser beams are injected through a wall member of the channel at an end surface of a transparent container such that an optical axis of the beams is parallel to and just below a liquid surface (specifically, at a depth within 3 mm from the liquid surface). In this case, the laser beams pass through the wall member of the end surface of the container and further pass just below the liquid surface, and the specific surface region of the liquid in the vicinity of the end surface becomes the hottest and the surface tension of that region becomes the lowest. As a result, a flow is generated in the surface region of the liquid toward the direction away from the end surface, and thus an amount of the liquid moves.

In a particularly preferred embodiment, the irradiation is performed such that the upper edge of the beam diameter region is located at a position which is deeper than the liquid surface by the millimeter order (for example, 1 mm to 1.5 mm) deeper, so that the upper edge of the beam diameter region (beam diameter of about 3 mm) does not directly touch the liquid surface.

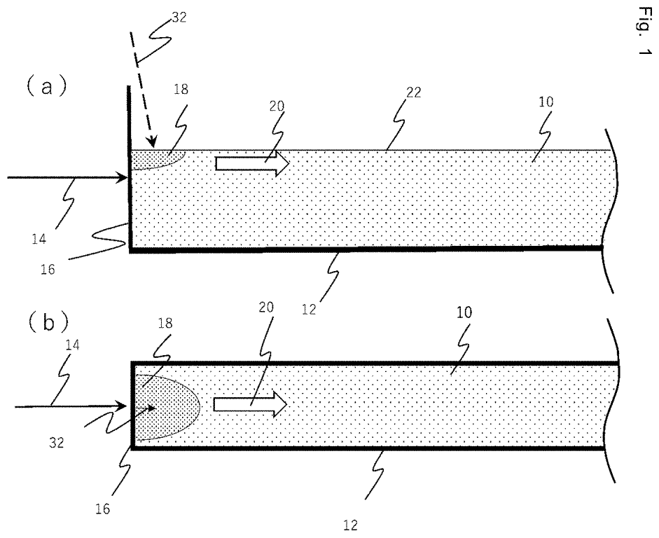

Referring to FIG. 1 showing this embodiment, FIG. 1(a) is a schematic side view of a container 12 made of a transparent material containing, as a liquid 10, water which contains dispersed fine particles, and FIG. 1(b) is a schematic view of the transparent container 12 from its above. The transparent container 12 is in the form of an elongated open channel having, for example, a rectangular cross section, and has an end surface 16 at its one end. In the transparent container 12, the water containing the fine particles in the dispersed state is adjacent to air, and the liquid side of the gas-liquid interface 22 corresponds to the surface region of the liquid. The laser beams 14 are applied into the liquid at the end surface 16 through the wall member thereof just below the gas-liquid interface, for example, below the liquid surface (for example, at a position 3 mm downward from the liquid surface) so that the optical axis of the beams is parallel to the liquid surface as shown in the drawing.

When the laser beams are made incident in this way, the surface region 18 adjacent to the end surface 16 (corresponding to the specific surface region) is locally heated by the fine particles present there which efficiently absorb the beam energy, so that a temperature gradient is formed between the region 18 and the unheated region (at a relatively low temperature) around the region 18, resulting in the formation of the corresponding surface tension gradient, whereby a rightward liquid flow is formed in the surface region (see arrow 20). As shown in the drawing, the shape of the gas-liquid interface is an elongated rectangle, and the region of the relatively low temperature in the surface region of the liquid is located substantially on the right side of the heated region 18 as can be seen from FIG. 1(b). Therefore, the liquid flow formed in the surface region of the liquid flows substantially goes rightward (in the direction of arrow 20).

In other preferred embodiment, the laser beams are injected through the wall member at the end surface of the container such that they pass through the liquid and travels diagonally toward the gas-liquid interface, that is, the optical axis of the beams is slanted (i.e., intersects) with respect to the liquid surface. In this case, the laser beams are irradiated such that the incident angle of the beams at the gas-liquid interface (that is, the angle formed by the optical axis of the beams and the vertical line at the gas-liquid interface) is equal to or larger than the critical angle. In this way, the beams passing through the liquid are totally reflected at the gas-liquid interface, and the irradiated beam energy is not emitted to the outside of the liquid at the reflection point, that is, not ejected into the gas phase, but reflected and travels through the liquid, which contributes to local heating of the surface region of the liquid near the reflection point (which region corresponds to the specific surface region). That is, the temperature of the specific surface region of the liquid in the vicinity of such reflection point is high relative to the surface region around the specific surface region. As a result, a liquid flow is formed in the surface region of the liquid from the reflection point toward its outward.

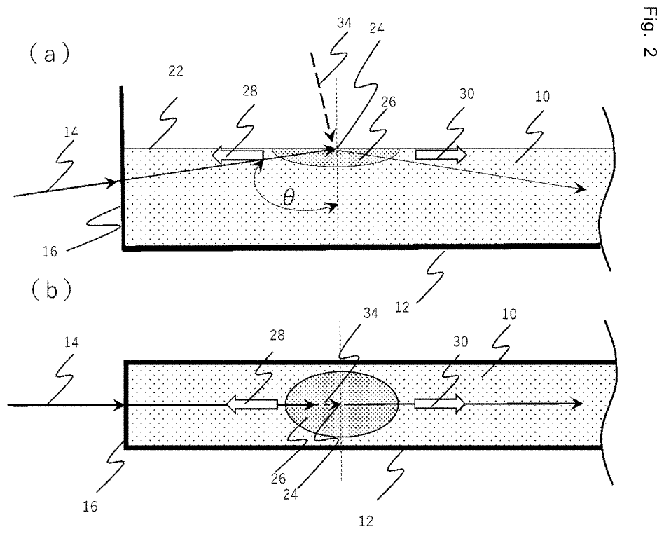

Reference is made to FIG. 2 showing the above embodiment. Similarly to FIG. 1, FIG. 2(a) schematically shows a state in which the transparent container 12 containing the liquid 10 which contains the fine particles is viewed from its side, and FIG. 2(b) schematically shows a state in which the transparent container is viewed from its above. The laser beams 14 are injected into the liquid just below the gas-liquid interface 22 of the liquid, for example, at a lower position from the interface (a position approximately 2 mm deeper from the surface of the liquid) through the wall member of the end surface 16 of the transparent container, and then travels toward the reflection point 24. The incident angle θ of the beams is preferably the critical angle (48.6° when the liquid is water while the gas is air) or more, more preferably 80° or more, and for example, about 84°.

In the above case, all the injected beams are reflected at the reflection point 24, and the fine particles existing in the surface region 26 (corresponding to the specific surface region) near the reflection point 24 absorb also the energy of the reflected beams, and are locally heated. That is, the surface region 26 can absorb the energies of both of the incident beams and the reflected beams. A temperature gradient is formed between the heated region 26 and the non-heated region (at a relatively low temperature) around the heated region, resulting in a surface tension gradient, which leads to the formation of a leftward liquid flow (see arrow 28) and a rightward liquid flow (see arrow 30).

In the illustrated embodiment, since the shape of the gas-liquid interface is an elongated rectangle as in the case of FIG. 1, the region where its temperature is relatively low in the surface region of the liquid is present substantially on the both sides of the heated region 26 (the left and right sides from the heated region 26 in the illustrated embodiment) as can be seen from FIG. 2(b), the formed liquid flows travel from the heated region towards the both sides as shown with the arrows 28 and 30, respectively. It is noted that the laser beams are really refracted when they pass through the wall member, but such refraction is omitted in the drawing for the sake of simplicity.

The laser beams can enter through the wall member of the container which contains the liquid, so that they indirectly irradiate the specific surface region of the liquid as described above with reference to FIGS. 1 and 2. In other embodiment, the liquid is charged in a container in the form of an open channel, and the specific surface region of the liquid is directly irradiated with the laser beams from the above of the liquid. Such direct irradiation is shown by dashed arrows 32 and 34 in FIGS. 1(a) and 2(a), respectively. The direct emission may be performed such that the angle formed by the optical axis of the laser beams with the gas-liquid interface (that is, the incident angle as shown in the drawing) is 90°, but it is more preferable that the beams are made obliquely incident at an angle smaller than 90° as shown in the drawing, so that a cross-sectional area of the irradiation at the liquid surface increases, which makes it possible to efficiently heat the vicinity of the liquid surface.

As described above, in order to carry out the method for forming the fluid flow according to the present invention, it is sufficient that the liquid side of the interface between the liquid containing the fine particles and its adjacent gas phase, that is, the specific surface region of the liquid is locally irradiated, so that the specific surface region can be locally heated. The local irradiation means that only the specific surface region of the liquid is irradiated, and for example, collecting the laser beams on the specific surface region heats such region. Such method for forming the liquid flow can be used as a pump for moving an amount of the liquid in the sense of flowing the liquid.

In the method for forming the liquid flow according to the present invention, a flowing direction of the liquid can be switched by combining the method described with reference to FIG. 1 and the method described with reference to FIG. 2. Specifically, as shown in FIG. 1, the laser beams are injected through the end surface of the container such that the optical axis of the beams are parallel to the gas-liquid interface so as to heat the specific surface region adjacent to the end surface, so that the rightward liquid flow (arrow 20) is formed. Then, as shown in FIG. 2, the specific surface region in the vicinity of the reflection point 24 is irradiated diagonally through the end surface 16 of the container such that the laser beams are totally reflected at the gas-liquid interface so as to heat the specific surface region in the vicinity of the reflection point, so that the leftward liquid flow (arrow 28) is formed. Therefore, by changing the incidence angle of the laser beams injected through the same end surface 16 of the transparent container, the rightward liquid flow and the leftward liquid flow can be formed. That is, the flow direction of the liquid can be switched, that is, switching can be done.

It is noted that as to switching of the liquid flow, the direct irradiation with the laser beams 32 and the direct irradiation with the laser beams 34 may be used to form the rightward liquid flow. It is of course possible to combine the indirect irradiation and the direct irradiation.

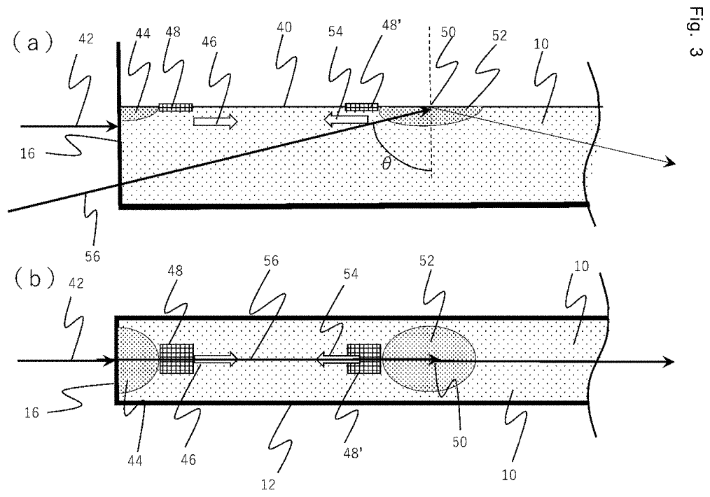

In one embodiment, first, as shown in FIG. 3(a), the laser beams 42 are applied through the end surface 16 of the transparent container such that the optical axis of the beams is parallel to the gas-liquid interface 40 and the upper edge of the beam area is located several millimeters deeper from the surface of the specific surface region 44 and adjacent to the end surface, so that the upper edge of the laser beam area does not directly touch the liquid surface. As a result, the fine particles contained in the specific surface region 44 absorb the beam energy and the region becomes relatively high in its temperature, and thereby the surface tension thereof becomes relatively small, so that the rightward liquid flow (arrow 46) is formed. When an object 48 is floated on or near (for example, adjacent to) the specific surface region 44, the object 48 moves rightward on the formed liquid flow, and it stops at a position of the object 48′, for example, by stopping the laser irradiation or short while irradiation under the total reflection condition.

Therefore, the present invention also provides a method for moving an object by placing it on the liquid flow formed by the method for forming the liquid flow according to the present invention. That is, the method for moving the object of the present invention is characterized in that in the method for forming the liquid flow of the aspect according to the present invention, while the object to be moved is floated on the surface region of the liquid, such floated region of the surface region or a surface region of the liquid which is located near (for example, adjacent to) the floated region is irradiated as “the specific surface region of the liquid” with the laser beams so that the liquid flow is formed, whereby the floated object is moved on the formed liquid flow. It is noted that the “floated region” means a region where the object is present, and the region or a surface region of the liquid near (for example, adjacent to) such region is irradiated with the laser beams. In this case, the floated region or the surface region of the liquid in the vicinity of the floated region corresponds to the specific surface region of the liquid.

Such method for moving the object of the present invention may be used in the case in which a liquid containing fine particles is contained in a microspace (such as a microchannel) of a microchip wherein a predetermined portion of the microspace (corresponding to the specific surface region of the liquid) is irradiated with laser beams so as to form a liquid flow, and an object is floated on the liquid flow so as to move the object. For example, the method for moving the object of the present invention can be used as a method for operating a microchip in which a specific surface region of a liquid containing a predetermined object(s) (for example, an antigen) is irradiated with the laser beams to form a liquid flow on which the object is placed and moved. Furthermore, since the antigen can be bound to an antibody incorporated in the microchip by such being moved, the method for moving of the present invention can be used for an analysis method using the microchip.

In the method for moving of the present invention, the object is to be placed on the formed liquid flow, and the object can be placed at the starting of the liquid flow (on the specific surface region of the liquid to be irradiated with the laser beams) or in middle of the liquid flow (other liquid flow that is resulted one after another from the movement of the liquid flow in the specific surface region formed by the irradiation of the laser beams). In the former case, the floated region of the object corresponds to the specific surface region. In the latter case, the floated region of the object is located near (including adjacent) the specific surface region of the liquid, in which case the object floated on the surface region of the liquid is located in the vicinity of the specific surface region of the liquid away from that region toward a direction along which the object is to be moved. In order that the object is floated on the liquid flow, it is necessary to float the object without being excessive away from the specific surface region.

Next, the specific surface region 52 is irradiated with the laser beams 56 from a lower incident position than that of the laser beams 42 at the end surface 16 such that the incident angle is 8 (theta) at the reflection point 50 just right side of the object 48′ and the beams are totally reflected at the reflection point. As a result, the fine particles contained in the specific surface region 52 absorb the beam energy and the region becomes relatively high in its temperature, and the surface tension thereof becomes relatively small, so that a leftward liquid flow (arrow 54) is formed. As a result, the object 48′ floated in the specific surface region 52 on the left side of the reflection point 50 moves leftward.

In FIG. 3, the object 48 is shown in a state of being adjacent to and floated on the specific surface regions 44 and 52, but may be floated on the specific surface region. The object may be any suitable object which is to be contained in the specific surface region. For example, the object may be dispersed matters, granules, dissolved matters or the like (e.g. agents, cells, antibodies, etc. contained in a biochip) contained within and/or adjacent to the specific surface region. The object may be present only in the specific surface region of the liquid surface and/or in the vicinity thereof, but in other embodiment, it may be present throughout the liquid. When the objects are floated only on the specific surface region, it corresponds to the former embodiment. The term “float” means the case of being floated on the liquid surface of the specific surface region and/or the case of being present in the surface region.

In the method for forming the liquid flow according to the present invention, since the flow of an amount of the liquid itself is formed, a relatively larger object can be moved. Specifically, the object to be floated on the liquid surface may have a size of the order from micrometers to millimeters, and for example, a plastic sheet piece having a size of 2 mm×2 mm (thickness 1 μm to 1 mm) can be moved.

In one embodiment, when various treatments of cells or the like are performed in the field of life science, the cells or the like can be treated as an object in the method of the present invention, and the liquid of the present invention containing the cells or the like is moved in a microchannel. A treatment necessary for the cells and the like can be performed during such movement. For example, the method of moving the object of the present invention can be used in the case of analysis using a microchip in which a sample is moved to a predetermined place in a microchannel of the microchip and processed there in order to react the sample with a specific reagent.

In other embodiment, the method for forming a liquid flow of the present invention can be used for sieving a mixture containing substances having various sizes. Specifically, as shown in FIG. 1, the mixture to be sieved is charged in the vicinity of the end surface 16 of the transparent container 12 containing a liquid, and the surface region of the end of the container is designated as the “specific surface region of the liquid” 18, which is irradiated with the laser beams 14 to form a liquid flow from the end toward the other end as shown with the arrow 20.

A plurality of meshes are arranged in middle of the liquid flow (arrow 20) in the transparent container such that the flow passes through the meshes of which mesh openings become stepwise smaller. Since the mesh opening through which the substance can pass has been predetermined depending on the size of the substance, the mixture of the substances can be sieved into substance size portions based on the mesh sizes.

### Example 1

Water which contained gold nanoparticles as the fine particles was charged, as the liquid 10, in a rectangular parallelepiped transparent glass container 12 (8 mm (width)×100 mm (length)×18 mm (height), end surface size: 8 mm×13 mm). It is noted that the container was an open container without a lid, and the water depth was 13 mm. The transparent container was made of glass sheets having a thickness of 2 mm.

The water contained 2.2×10⁻⁸% by mass of the gold nanoparticles (length-based average particle diameter: 15 nm). The absorption coefficients of such gold nanoparticles were measured using a UV-vis device, and the measured results are shown in FIG. 4. The absorption coefficient showed its maximum value (13.8×10⁸ M⁻¹ cm⁻¹) at a wavelength of 522 nm. The measurement of the absorption coefficient was carried out using UH5300 (manufactured by HITACHI).

As shown in FIG. 1, laser beams 14 were injected through the end surface 16 of the container at room temperature (25° C.) such that the optical axis of the beams was substantially parallel to the liquid surface. The injection position was about 3 mm below the liquid surface. The used laser light beam source was manufactured by OXIDE (product name: CW 3-wavelength laser, power: 730 mW). Green laser beam (wavelength: 532 nm) out of the three wavelengths was used.

As a result, as shown in FIG. 1, a liquid flow was formed as shown with the arrow 20 almost simultaneously with the injection. The flow velocity of this liquid flow was about 0.63 mm/sec at the maximum. When the surface temperature of the liquid was measured with a thermography camera, the temperature of the specific surface region adjacent to the end surface 16 was 32° C., which was about 5° C. higher than that of the other region around the specific surface region (for example, at a position about 30 mm away from the end surface 16 toward the right).

### Example 2

Similarly to Example 1, the water containing the gold nanoparticles was supplied in the container. Then, as shown in FIG. 2, the laser beams 14 were injected obliquely upward through the end surface 16 of the container such that the beams were totally reflected at the liquid surface at the reflection point 24. The incident angle θ (theta) of the laser beams was 84°.

As a result, as shown in FIG. 2, almost simultaneously with the emission, a liquid flow was formed from the reflection point 24 toward the left as shown with the arrow 28, and a liquid flow was formed from the reflection point 24 toward the right as shown with the arrow 30. The maximum flow velocity of these liquid flows were about 0.7 mm/sec in the left direction and about 0.3 mm/sec in the right direction, respectively. Further, when the surface temperature of the liquid was measured by the thermography camera, the temperature was 32° C. in the vicinity of the reflection point, and temperatures were 27° C. in the surface regions about 30 mm rightward away and also leftward away from the reflection point 24, respectively. The temperatures of the surface regions adjacent to both end surfaces were 25° C.

### Example 3

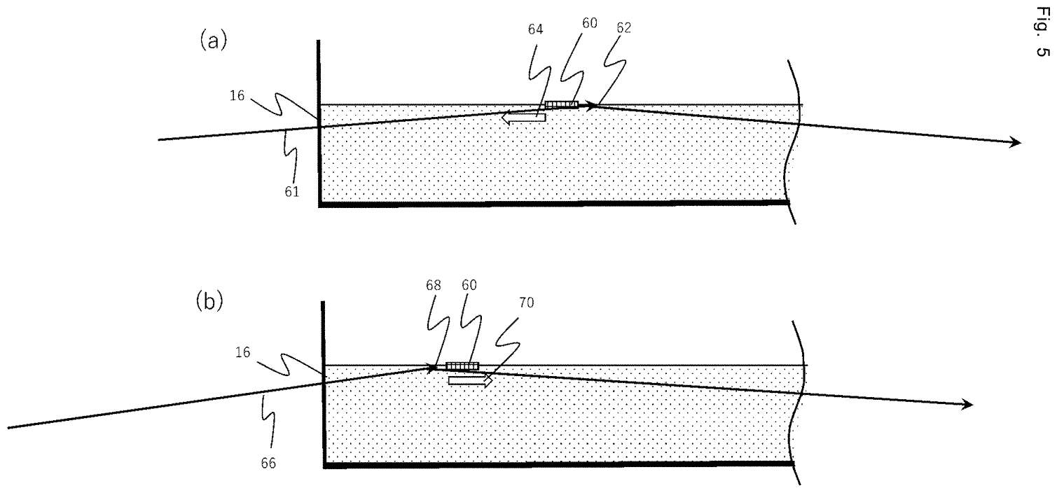

Similarly to FIG. 1 and Example 1, the water containing the gold nanoparticles was charged in the container. As shown in FIG. 5(a), a commercially available plastic sheet (2 mm×2 mm, thickness 0.25 mm) as an object was floated on the liquid surface at the position of the object 60 as shown.

In the same manner as in Example 2, the laser beams 61 were obliquely injected through the end surface 16 such that they were totally reflected at the reflection point 62 which is immediately on the right side of the plastic sheet 60. The incident angle θ was 84°. As a result, the temperature in the region near the reflection point 62 was increased and the surface tension of that region became smaller than that of the other region around the former region, so that a leftward liquid flow was formed as shown with the arrow 64 and thereby the plastic sheet 60 was moved to the left. The travel distance of the plastic sheet 60 in 20 seconds was about 7 mm.

Next, as shown in FIG. 5(b), the laser beams 66 were obliquely injected through the end surface 16 in the same manner as in Example 2 so as to be totally reflected at the reflection point 68 which is immediately on the left side of the plastic sheet 60. It is noted that the incident angle θ was 84°. As a result, the temperature in the region near the reflection point 68 was increased and the surface tension of said region became smaller than that of the other region around said region, so that a rightward liquid flow was formed as shown with the arrow 70 and the plastic sheet 60 was moved to the right. The travel distance of the plastic sheet 60 in 20 seconds was about 5.5 mm.

The above results mean that the flow direction of the liquid flow can be changed, that is, switched. By utilizing this, it becomes possible to form a liquid flow in a desired flow direction by the laser beams so as to move the object.

### INDUSTRIAL APPLICABILITY

As clearly seen from the above descriptions, in the method for forming the liquid flow according to the present invention, the liquid flow can be formed by irradiating the specific surface region of the liquid contained in the transparent container with the laser beams. Furthermore, forming such liquid flow means that an amount of the liquid can be moved as predetermined in the transparent container. By utilizing this, an amount of the liquid contained in the transparent container can be moved to be treated as necessary, and after the treatment, the liquid flow can be formed by irradiating the laser beams again to move an amount of the liquid in a non-contact manner as required. For example, in the field of the life science, it is necessary to move a very small amount of a sample in order to appropriately process the sample. When the sample is placed on the liquid flow formed by the method for forming the liquid flow according to the present invention, the sample can be easily moved.

### REFERENCE SIGNS LIST

10 . . . fine particle containing liquid
12 . . . container
14 . . . laser beams
16 . . . end surface of container
18 . . . specific surface region
20 . . . liquid flow direction
22 . . . gas-liquid interface
24 . . . reflection point
26 . . . specific surface region
28 . . . liquid flow direction
30 . . . liquid flow direction
32, 34 . . . direct irradiated laser beams
40 . . . gas-liquid interface (or liquid surface)
42 . . . laser beams
44 . . . specific surface region
46 . . . liquid flow direction
48, 48′ . . . object
50 . . . reflection point
52 . . . specific surface region
54 . . . liquid flow direction
56 . . . laser beams
60 . . . object
61 . . . laser beams
62 . . . reflection point
64 . . . liquid flow direction
66 . . . laser beams
68 . . . reflection point
70 . . . liquid flow direction

1. A method for forming a liquid flow in a surface region of a liquid, the method comprising irradiating a specific surface region of the liquid which contains fine particles dispersed therein with laser beams of which fluxes are parallel such that a temperature of the specific surface region of the liquid is high relative to that of a temperature of other surface region of the liquid around the specific surface region so as to form a temperature gradient between both of the surface regions of the liquid.

2. The method for forming the liquid flow according to claim 1, wherein the specific surface region of the liquid which contains the dispersed fine particles is directly irradiated with the laser beams.

3. The method for forming the liquid flow according to claim 1, wherein the specific surface region of the liquid which contains the dispersed fine particles is indirectly irradiated with the laser beams through a wall member of a container in which the liquid is charged.

4. The method for forming the liquid flow according to claim 3, wherein irradiation of the laser beams is performed such that the laser beams are totally reflected at a gas-liquid interface.

5. The method for forming the liquid flow according to claim 1, wherein the fine particles are gold nanoparticles.

6. The method for forming the liquid flow according to claim 5, wherein a length based average diameter of the fine particles is 1 nm to 100 nm.

7. The method for forming the liquid flow according to claim 6, wherein the liquid which contains the fine particles has a maximum absorption coefficient at a wavelength within a range of a wavelength of the laser beams used ±40 nm.

8. The method for forming the liquid flow according to claim 7, wherein the liquid contains the fine particles in a content of 0.5×10⁻⁸% by mass to 10.0×10⁻⁸ by mass.

9. The method for forming the liquid flow according to claim 8, wherein the liquid which contains the fine particle has an absorption coefficient of 9.5×10⁸ M⁻¹ cm⁻¹ to 14×10⁸ M⁻¹ cm⁻¹.

10. The method for forming the liquid flow according to claim 1, wherein the liquid which contains the fine particles is contained in a microchip as a container.

11. The method for forming the liquid flow according to claim 10, wherein the microchip is a biochip, a tissue chip or an in vitro human model.

12. A method for moving an object, the method comprising forming the liquid flow in the surface region of the liquid according to the method of claim 1, wherein while the object is floated on and/or inside of the surface region of the liquid, the surface region where the object is floated or a surface region in the vicinity of the former surface region is irradiated with the laser beams as the specific surface region, thereby forming the liquid flow, on which the object is moved.

13. The method for moving the object according to claim 12, wherein the object is afloat on the liquid.

14. The method for moving an object according to claim 13, wherein the object is present inside of the surface region of the liquid.

15. A device, the device comprising
a container which includes a liquid containing fine particles, and
a laser beam source emitting laser beams of which fluxes are parallel so as to irradiate a specific surface region of the liquid with the laser beams, so that a temperature of the specific surface region of the liquid is high relative to that of a temperature of other surface region of the liquid around the specific surface region so as to form a temperature gradient between both of the surface regions of the liquid.

16. The device according to claim 15, wherein the container comprises an end surface into which the laser beams from the laser beam source are injected and through which the laser beams pass.

17. The device according to claim 16, wherein the laser beams injected into the end surface pass through the end surface obliquely upward.

18. The device according to claim 17, wherein the laser beam source is configured such that the laser beams are reflected at a liquid surface after being injected.
